(19) United States
(12) Patent Application Publication
(10) Pub. No.: US 2024/0211875 A1
(43) Pub. Date: Jun. 27, 2024

(54) SYSTEM AND METHOD FOR REAL-TIME ASSET LOCATION HAVING AN INTUITIVE DASHBOARD

(71) Applicant: Great Lakes Rubber & Supply, Inc., Glendale, WI (US)

(72) Inventor: Mary C. Dillon, Phoenix, AZ (US)

(21) Appl. No.: 18/518,037

(22) Filed: Nov. 22, 2023

Related U.S. Application Data
(60) Provisional application No. 63/384,939, filed on Nov. 23, 2022.

(51) Int. Cl. G06Q 10/087; G06K 19/07; G08B 21/12; G08B 21/18; H01Q 1/22; H04W 4/029

(52) U.S. Cl. CPC G06Q 10/087; G06K 19/0723; G08B 21/12; G08B 21/182; H01Q 1/2208; H04W 4/029

(57) ABSTRACT

The invention relates to an inventory management system including a real-time asset locating software solution integrated with an intuitive dashboard. This system serves the purpose of providing real-time tracking and monitoring of assets and personnel.

### BACKGROUND

### Field of the Invention

The field of the present invention relates to the development of an intuitive, user friendly, customizable, and configurable 2D and 3D dashboard. This dashboard serves to visually depict real-time location tracking of a uniquely identified tag associated with a uniquely identified asset to enable swift decision-making by visually representing the assets and their locations. The present invention encompasses the display of visual representations, avatars, or digital twins of assets, individuals, or objects within a specified environment, which may include rooms with distinct zones. The main objectives are to streamline tracking, improve operational processes, enhance inventory, management, boost productivity and efficiency, reduce costs related to lost assets, ensure compliance and auditability, and improve safety for individuals and objects. Furthermore, this innovation plays a vital role in the implementation of policies aimed at achieving “as low as reasonably achievable” (ALARA) exposure levels, reducing potential exposure to hazardous environments for all types of assets. This includes scenarios such as identifying employees unrecognizable by remote camera monitoring because of the fully enclosed PPE they are required to wear in these areas.

Furthermore, this invention relates to a steerable phased array bi-directional passive RFID antenna. This antenna's primary purpose is to establish instantaneous communication with passive RFID tags, allowing for real time asset tracking. Notably, the RFID tags are solely powered and activated by electromagnetic waves induced by the antenna.

### Description of Related Art

In contrast to existing real-time inventory management systems (RTLS) which rely on active RFID tags, this innovation distinguishes itself. In existing systems, active RFID tags have their own internal power source, often in the form of batteries, which may necessitate periodic replacement and contribute to increased stag size. Additionally, conventional passive RTLS systems typically require the passive RFID tag to come within 10 feet or less of the antenna within a direct line of sight to be accessed.

To reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. 8,742,896 B2 (Eloy) describes a steerable phase array antenna RFID tag locater and tracking system that comprises at least one steerable phase array antenna, RFID reader and a controller to acquire, locate and track RFID tags used for tracking and locating RFID tags, including where at least one steerable phase array antenna may locate the tags associated with items in three dimensions in real time, through the use of a beam steering unit and controller therewith to control the direction of a beam launched by at least one steerable phase array antenna.

U.S. Pat. No. 8,698,575 B2 (Bloy) describes a switching arrangement for controlling the polarization of multi-element antenna arrays and more particularly to antenna arrays used in Radio Frequency Identification Systems where the antenna switching is arranged with a quadrature arrangement of transmission lines through which a desired signal path may be configured via switches selectively grounding junctions of the switching arrangement with routing a signal path from an input port to one or both of first and second output ports to generate a signal with vertical linear polarization, horizontal linear polarization or circular polarization where the selected polarization may be changed as desired and/or multiple antenna switching arrangements applied to enable simultaneous signals with different polarizations.

U.S. Pat. No. 8,659,430 (Bloy) describes a radio frequency signal acquisition and source location system in three dimensions including a first signal acquisition and source location module comprising an RF transceiver coupled to an antenna, the antenna provided with an interrogation signal steerable with an electronic steering circuit. Bloy also discloses a processor operatively coupled to the RF transceiver and the electronic steering circuit, the processor provided with a data storage for storing a signal data record for each of at least one response signal(s) received by the RF transceiver(s) where the signal data record including a signal identification, a received signal strength indicator and an RF signal direction along which respective signal(s) are received by the antenna, the RF signal direction derived from the electronic steering circuit. Bloy also discloses a position logic operative upon the data record(s) derives a three-dimensional signal origin location of each response signal.

U.S. Pat. No. 8,599,024 B2 (Bloy) describes a radio frequency environment monitoring system for object presence feedback particularly for RFID tagged and/or untagged object monitoring via analysis of changes to the monitored RF environment occurring as the objects present in the monitored area that are varied in position and or numbered for monitoring untagged objects in a target area including calibrating a radio environment monitoring system including a rules engine and a baseline data set for a target area by recording a set of changes to the RF environment fingerprint of the target area received by the radio environment monitoring system as the target area is filled with objects where during system operation, scanning the target area with the radio environment monitoring system for a current RF environment fingerprint, comparing the current RF environment fingerprint with the baseline data set by a rules engine and reporting an output of the rules engine.

U.S. Pat. No. 8,493,182 B2 (Bloy) describes a touch free identification, location and/or tracking systems such as RFID identification, location and/or tracking system utilizing Phase Ranging to determine the distance of a target RFID from the system antenna where a phase ranging RFID location system for phase ranging the distance an RFID tag is from an RFID location system antenna along the interrogation signal beam, based upon the phase readings included in data sets obtained from monitoring reply signals corresponding to interrogation signals at multiple frequencies and a common interrogation signal beam direction; by comparison of measured phase and frequency data sets with theoretical phases calculated with respect to the same frequencies over a range of positions corresponding to a beam extent of the interrogation signal.

U.S. Pat. No. 8,421,631 B2 (Bloy) describes a radio Frequency (RF) signal acquisition and source location in three dimensions where a radio frequency signal acquisition and source location system includes a first signal acquisition and source location module comprising an RF transceiver coupled to an antenna, the antenna provided with an electronic steering circuit steerable by an electronic steering circuit and where a processor is operatively coupled to the RF transceiver and the electronic steering circuit, the processor provided with a data storage for storing a signal data record for each of at least one response signal(s) received by the RF transceiver(s). Bloy also discloses a signal data record including a signal identification, a received signal strength indicator and an RF signal direction along which respective signal(s) are received by the antenna, the RF signal direction derived from the electronic steering circuit where a position logic is operative upon the data record(s) deriving a three-dimensional signal origin location of each response signal.

U.S. Pat. No. 8,344,858 B2 (Bloy) describes a steerable phase array antenna RFID tag locater and tracking system comprising at least one steerable phase array antenna, RFID reader and a controller to acquire, locate and track RFID tags for tracking and locating RFID tags, including where at least one steerable phase array antenna may locate the tags associated with items in three dimensions in real time, through the use of a beam steering unit and controller therewith to control the direction of a beam launched by the at least one steerable phase array antenna.

U.S. Pat. No. 8,344,823 B2 (Bloy) describes a switching arrangement for controlling the polarization of multi-clement antenna arrays and more particularly to antenna arrays used in Radio Frequency Identification Systems with a quadrature arrangement of transmission lines through which a desired signal path may be configured via switches selectively grounding junctions of the switching arrangement where the desired path routing a signal from an input port to one or both of first and second output ports to generate a signal with vertical linear polarization, horizontal linear polarization or circular polarization and the selected polarization may be changed as desired and/or multiple antenna switching arrangements applied to enable simultaneous signals with different polarizations.

U.S. Pat. No. 8,159,367 B2 (Hofer) describes a touch free identification, location and/or tracking systems utilizing noise validated phase ranging to determine the distance of a target RFID from the system antenna with noise validated phase ranging RFID location used for validating a distance output of a phase ranging RFID location system is based upon the phase readings included in data sets obtained from monitoring reply signals corresponding to interrogation signals at multiple frequencies and a common interrogation signal beam direction; by comparison of measured phase and frequency data sets with theoretical phases calculated with respect to the same frequencies over a range of positions corresponding to a beam extent of the interrogation signal where the distance output validated by comparison with theoretical threshold data processed to generate an extreme values distribution from which a cumulative distribution function is extracted and against which a confidence level is applied.

U.S. Pat. No. 8,120,488 B2 (Bloy) describes a radio frequency environment monitoring system for object presence feedback of RFID tagged and/or untagged object monitoring via analysis of changes to the monitored RF environment occurring as the objects present in the monitored area are varied in position and or number for use in monitoring untagged objects in a target area including calibrating a radio environment monitoring system including a rules engine and a baseline data set for a target area by recording a set of changes to the RF environment fingerprint of the target area received by the radio environment monitoring system as the target area is filled with objects. Bloy also discloses that during system operation, scanning the target area with the radio environment monitoring system for a current RF environment fingerprint, comparing the current RF environment fingerprint with the baseline data set by a rules engine and reporting an output of the rules engine.

US Patent US 20180199639 A1 (Insley) describes determining conditions of personal protection articles against at least one criterion that governs use of the PPE article in a working environment where data from a PPE article is configured with a smart tag and a sensing device are processed in a data processing system to determine whether the condition of the PPE article satisfies the at least one predetermined criterion.

U.S. Pat. No. 8,326,451 B2 (Schantz) describes an inventory control and method that uses a locating device associated with a mover and identifies an ID tagged asset using an ID reader also associated with the mover by utilizing a RFID or barcode technology for the ID tag and where the locating device may utilize near-field location technology, signals-of-opportunity, or other RTLS technologies.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY

The present invention encompasses various features, including a real-time asset locating software solution integrated with an intuitive dashboard, which forms an integral part of the Real-Time Location System (RTLS). This system serves the purpose of providing real-time tracking and monitoring of assets and personnel.

Implementations of the RTLS system may consist of elements such as a defined location, physical assets (e.g., containers, boxes, packages), RTLS passive RFID tags (RTLS pRFID tags), RTLS antennas, RTLS communication protocols, and RTLS software complete with an optional 2D and 3D digital twin representation of asset's locations. Specific aspects of the RTLS system may involve designations like rooms with distinct zones, physical assets including personnel, RTLS passive RFID tags, RTLS antennas, protective monitoring devices like dosimeters, protective monitoring antennas, RTLS wireless communication protocols, and RTLS software featuring an RTLS dashboard and visualizer, optionally including “all clear” indicators for quick assessment.

Implementations of the RTLS system may provide a method for the collection, recording, and/or displaying of data related to an asset by using a protection monitoring device coupled to an asset to record protection related data such as a radiation exposure dose recorded by a dosimeter worn by an employee, a protection monitoring antenna placed near where the protection monitoring device will be used in operation and configured to transmit data collected by the protection monitoring device to a protection monitoring module; a RTLS tag coupled to the protection device such as a RTLS pRFID tag coupled to the dosimeter; and a RTLS antenna placed near where the RTLS tag will be used in operation such as a room; so that when the RTLS tag is near a predefined proximity to the RTLS antenna the RTLS tag becomes activated; the RTLS antenna may then transmit data related to the activated RTLS tag such as the RTLS tag's unique identifier, approximate time, day, or location when the RTLS tag was activated to a location based tracking system such as a RTLS asset monitoring system; then the RTLS system may collect, record, correlate, and/or display the transmitted data to a RTLS user such as on a visual dashboard. Particular aspects of the invention provide for data stored in the protection monitoring system, the location-based tracking system such as the RTLS asset monitoring system, and other relevant databases to be correlated to when the RTLS tag was activated such as an employee identification, employee's exposure to radiation (dose) at the time of RTLS tag activation. Aspects of the RTLS system may provide for optionally passing the RTLS tag transmitted data to a third-party application such as a monitoring database or a data historian database for collecting, historicizing, finding, analyzing, delivering and visualizing data and the RTLS system may optionally be configured to receive additional transmitted data from another third-party application such as a monitoring database such as sensor data collected from another software system.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that they can be their own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 representatively depicts an embodiment of an asset location software solution displaying the location of multiple assets on a dashboard view on a kiosk from location data received wirelessly from multiple RTLS tags through multiple RTLS antennas where the RTLS tags are optionally configured as RTLS passive radio frequency identification tags (RTLS pRFID tag) and the RTLS antennas are optionally configured as phased array bi-directional steerable antennas.

FIG. 2 representatively illustrates an asset configured as a dosimeter coupled to a RTLS pRFID tag.

FIG. 3 illustrates an asset configured as a package coupled to a RTLS pRFID tag.

FIG. 4 representatively illustrates an antenna configured as a steerable phased array bi-directional passive RFID antenna for receiving and/or transmitting radio frequency (RF) signals.

FIG. 5 representatively illustrates a dashboard view of a radiation protection locator that may display radiation dosing information such as dose rate and dose limit dose. percentage of dose rate and dose limits relative to an industry warning level or scale, activity, date, time, or other related information for a staff member wearing an RFID tagged dosimeter or piece of equipment with a dosimeter displayed as a virtual asset, an avatar, a digital twin, or an icon such as a person in a circle in possible proximity to an antenna, a physical location such as a zone such as zone RP Loc 1, zone RP Loc 2, or zone PR Loc 3, a region, such as region CLC556, or a region such as a collection of buildings.

FIG. 6 representatively illustrates a view of a radiological monitoring software and telemetry solution that may be configured to source, collect, or calculate radiation protection related information such as an employee or asset (equipment) name, an assigned dosimeter, a unique identifier, a received dose, a dosing rate, a dosing rate percentage, a dose, a dose limit, a dose limit percentage, a status, a date, a time, a location, a position, or a proximity

FIG. 7 representatively depicts an alternative 2D view perspective of an embodiment of a visual dashboard illustrating a possible current position of an asset or an object with a tag relative to a virtual antenna, a virtual physical location, a virtual region, a virtual zone such as a virtual zone 1, a virtual zone 2, a virtual zone 3, a virtual zone 4, and a virtual zone 5 or alternatively the 2D view perspective may be configured to show the historical path of an asset over time.

FIG. 8 representatively depicts a 2D perspective view of an embodiment of an asset's physical location such as an inventory location, an operations location, an overflow location, or a shelf location such as an upper shelf location wherein by selecting an asset or an object may present or highlight additional information related to the asset or the object such as a location, a name, a tag, or an activity.

FIGS. 9A, 9B and 9C representatively depict 3D perspective views of an embodiments of a dashboard view of an asset's physical location such as a package on a lower shelf, a middle shelf, or an upper shelf such as a 3D view of the 2D room shown in FIG. 8.

FIG. 10 representatively depicts a 2D view of an embodiment of a dashboard view of an asset's inventory status such as inventory consumed or inventory on hand.

FIG. 11A depicts a general process diagram of an embodiment of an asset location software solution receiving transmitted data from an employee worn dosimeter.

FIG. 11B is a continuation of FIG. 11A

FIG. 12 depicts a general process diagram of an embodiment of an asset location software solution receiving transmitted data such as location or position of object.

FIG. 13 depicts a general process diagram and parameters associated with a radiological monitoring, telemetry and location software solution configured to pass transmitted data such as data from a dosimeter and a wireless access point transponders to a third-party application such as a historical monitoring system via Accu-traq's adapter software.

FIG. 14 representatively depicts a diagram of a software solution configured with an antenna network transmitting data to a locally installed edge device configured to interface with a core services configured to interface with an adapter, a cloud service that may be coupled to a user interface and other services to provide a user interface, data tracking, data analytics, and data visualization.

Elements and acts in the figures are illustrated for simplicity and have not necessarily been rendered according to any sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

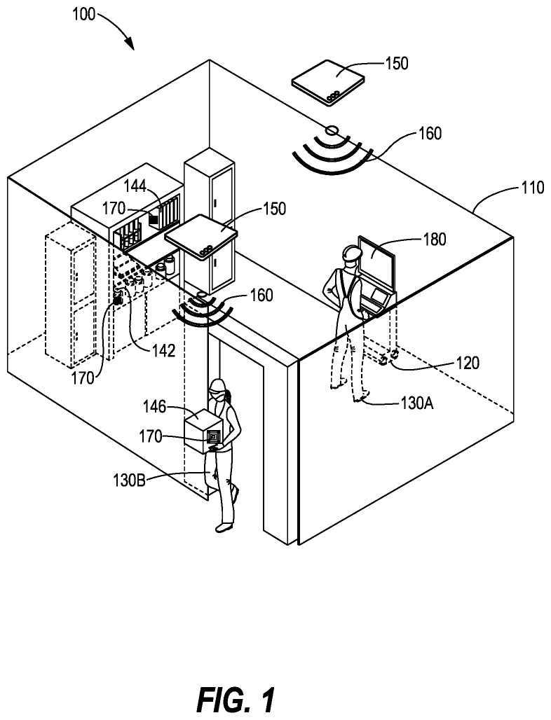

A real-time asset locating software solution with an intuitive dashboard (RTLS system) 100, according to various aspects of an embodiment of the invention provides for identifying, locating, inspecting, tracking, trending, mapping, surveying, capturing, analyzing, managing, securing, and improving the safety of assets. In one embodiment, the RTLS system 100, may comprise a location and an asset monitoring module. In one embodiment, the RTLS system 100 may comprise a location, an asset monitoring module, and RTLS software. In another embodiment, the RTLS system 100 may comprise a location, an asset monitoring module, a RTLS communication protocol, and RTLS software. In another embodiment, the RTLS system 100 may comprise a location, a RTLS tag, a RTLS antenna, a RTLS communication protocol, and a RTLS software. In another embodiment, the RTLS system 100 may comprise a location, an asset, a RTLS tag, a RTLS antenna, a RTLS communication protocol, and a RTLS software. In another embodiment, the RTLS system 100 may comprise a location, a physical asset, a digital asset, a RTLS tag, a RTLS antenna, a RTLS wireless communication protocol 160, and a RTLS software. In another embodiment, the RTLS system 100 may comprise a room 110, a package 146, a Steerable Phased Array Bi-Directional Passive RFID Antenna 150, a wireless communication protocol 160, a RTLS passive radio frequency identification (RFID) tag (RTLS pRFID tag) 170, and a RTLS dashboard 180 as shown in FIG. 1.

In one embodiment, the RTLS system 100 may comprise a location and a protection monitoring module. In another embodiment, the RTLS system 100 may comprise a location, a protection monitoring module, and a RTLS software. In another embodiment, the RTLS system 100 may comprise a location, a protection monitoring module, a RTLS communication protocol, and a RTLS software. In another embodiment, the RTLS system 100, may comprise a room 110, a dosimeter 210, a steerable phased array bi-directional passive RFID antenna 150, a RTLS wireless communication module 160, a RTLS pRFID tag 170, a protection monitoring device, a protection monitoring antenna, and a RTLS software.

In another embodiment, the RTLS system 100 may comprise a location, an asset monitoring module, and a protection monitoring module. In another embodiment, the RTLS system 100 may comprise a location, an asset monitoring module, a protection monitoring module, and a RTLS software. In another embodiment, the RTLS system 100 may comprise a location, an asset monitoring module, a protection monitoring module, a communication protocol, and a RTLS software. In another embodiment, the RTLS system 100 may comprise a location, a RTLS tag, a RTLS antenna, a protection monitoring device, a protection monitoring antenna, a RTLS communication protocol and a RTLS software. In another application, the RTLS system 100 may comprise a location, an asset monitoring module, a protection monitoring module, a RTLS communication protocol, a RTLS software, and a RTLS user.

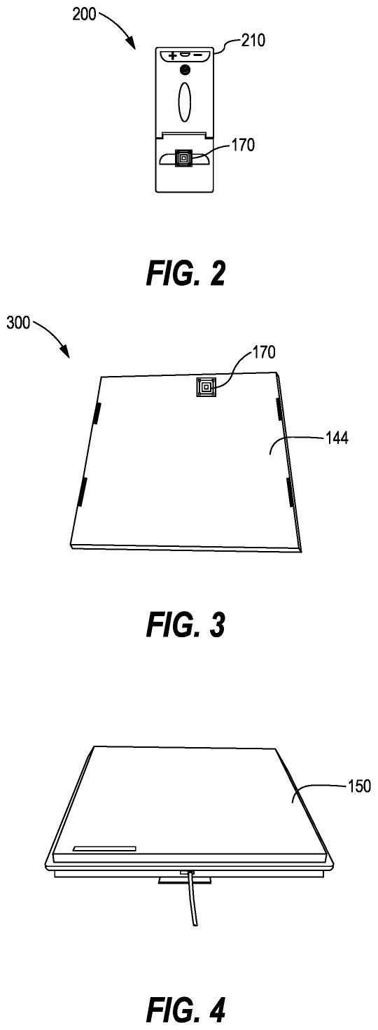

In another embodiment, the RTLS system 100 may comprise a room 100, a kiosk 120, a staff such as a staff 130A and a staff 130B, an asset, such as a container 142, a box 144, or a package 144, a RTLS antenna, a RTLS wireless communication protocol 160, and a RTLS tag such as a RTLS pRFID tag 170 as shown in FIG. 1. In another embodiment, the RTLS system 100 may comprise a dosimeter 210 coupled to a RTLS tag such as a RTLS pRFID tag 170 as shown in FIG. 2. In another embodiment, the RTLS system 100 may comprise a box 144 coupled to a RTLS tag such as a RTLS pRFID tag 170 as shown in FIG. 3. In another embodiment, the RTLS system 100 may be configured with an antenna configured to receive and/or transmit radio frequency (RF) signals as shown in FIG. 4.

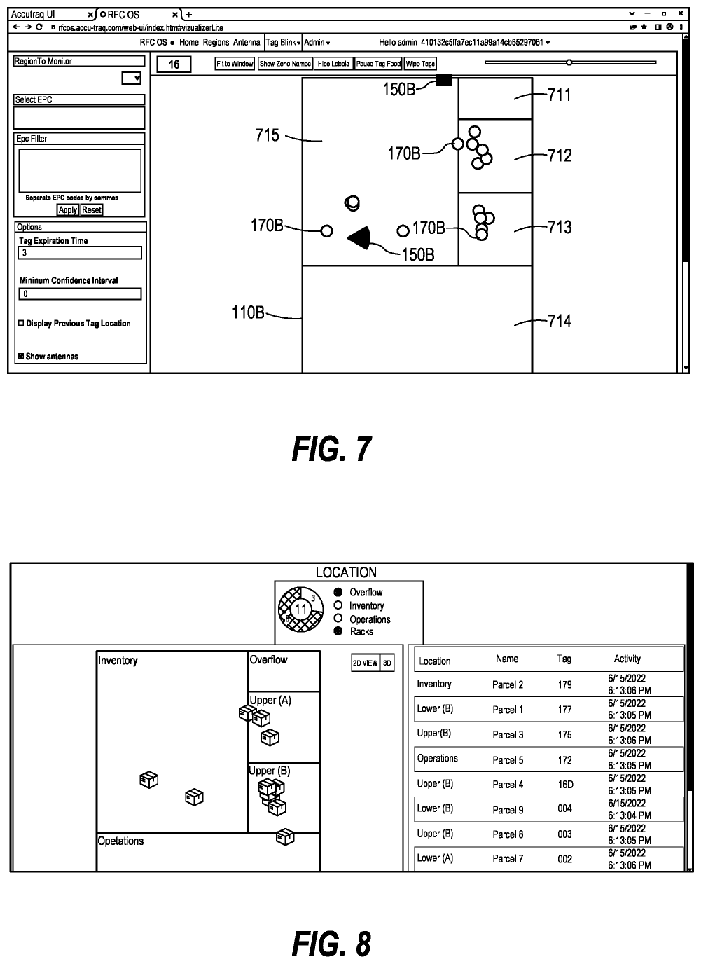

The location, according to various aspects of an embodiment of the invention provides an identification of an actual place, site, or position. In one embodiment, the location may comprise a coordinate such an x-axis, y-axis, or z-axis coordinate. In another embodiment, the location may be configured as an indoor location, an outdoor location, or a combination of indoor and outdoor location. In another embodiment, the location may comprise a navigational system such a global positioning system (GPS) coordinate. In another embodiment, the location may comprise a coordinate such as a proximity to another location, an object, an antenna, or another predefined area such as a plant, a facility such as a nuclear facility, a room 110, a kiosk 120, a doorway, a portal, a floorplan, a region, a zone, a shelf, a group, or another object. In another embodiment the location, may be configured to be represented virtually such as a virtual location, a two-dimension (2D) location, a three-dimension (3D) location, an image location such as a floorplan image, a location's digital twin, a location icon, a location picture, a location model, a location video, or another representation of the location. In another embodiment, the location may be configured to be represented virtually as a location with time related data. In one embodiment, a room 110 may be configured as a floorplan image. In another embodiment, a room 110 may be configured as a zone such as a zone 1, zone 2, zone 3, zone 4, and a zone 5. In another embodiment, a room 110 may be represented virtually as a virtual room 110B with a virtual zone such as a virtual zone 1 711, virtual zone 2 712, virtual zone 3 713, virtual zone 4 714, and a virtual zone 5 715 as shown in FIG. 7. The location, may however, be configured in any suitable manner to represent a physical location or communicate information about a physical location where an asset may be positioned.

The asset monitoring module, according to various aspects of an embodiment of the invention provides a structured framework for collecting, monitoring, and analyzing data related to asset identification, inspection, tracking, management, security, and compliance. In one embodiment, the asset monitoring module may comprise an asset, a RTLS tag, and a RTLS antenna. In another embodiment, the asset monitoring module may comprise an asset, a RTLS tag, a RTLS antenna, and a third-party asset monitoring device.

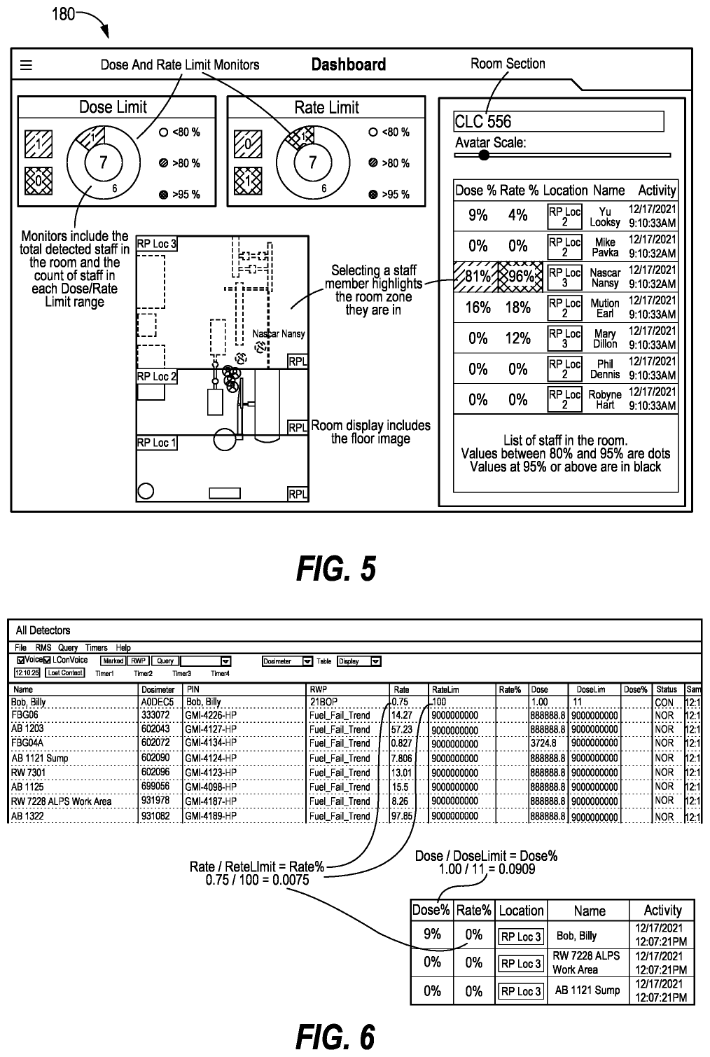

In one embodiment, the asset may be configured as a physical asset or a virtual asset. In one embodiment, the physical asset may be configured as a person such as a staff such as a first staff 130A or a second staff 130B, an employee, or a visitor, an object such as a badge, a container 142, a box 144, a package 146, an instrument, a control, a laptop, a key, a good, a tool, a personal protective equipment (PPE), a kiosk 120, a vehicle, a machinery, an equipment, or another physical item as shown in FIG. 1. In one embodiment, the virtual asset may be configured to represent the physical asset virtually such as an avatar, a digital asset, an asset's digital twin, an icon, an image, a picture, a video, a sketch, a model, or another digital representation of the asset as shown in FIG. 5 and FIG. 7 through FIG. 10. In one application, the kiosk 120 may be configured to facilitate assignment of an asset to a RTLS tag such as an employee checking in or out a dosimeter 210 with an associated RTLS tag, an employee checking out or returning a tool, or a package 146 being scanned to indicate the package 146 was placed on or removed from a specific shelf location.

The RTLS tag, according to various aspects of an embodiment of the invention provides for uniquely identifying an asset or a protection monitoring device. In one embodiment, the RTLS tag may be configured with a unique identifier such as a RTLS Tag ID such as a serial number or electronic product code (EPC). In another embodiment, the RTLS tag may be configured as an RTLS RFID tag such as a RTLS passive RFID tag (RTLS pRFID tag), a RTLS active RFID tag. In one embodiment, the RTLS pRFID tag may comprise a passive RFID tag integrated circuit and a passive RFID tag antenna. In another embodiment, the RTLS pRFID tag may be configured as a passive ultra-high frequency (UHF) RFID tag or a Radio Frequency Identification (RAIN) pRFID UHF tag. In another embodiment, the RTLS active RFID tag may comprise an active RFID tag integrated circuit, an active RFID tag antenna, and an internal power source. In another embodiment, the RTLS tag may be configured as a RTLS tag integrated with the asset, a RTLS tag coupled to the asset such as a RTLS pRFID tag coupled to a box 144 as shown in FIG. 3, a RTLS tag integrated with the protection monitoring device, or a RTLS tag coupled to the protection monitoring device such as a RTLS pRFID tag coupled to a dosimeter 210 as shown in FIG. 2. In another embodiment, the RTLS tag may be configured to be applied, installed, read, or operated in any orientation relative to the location, the asset, the RTLS antenna, the protection monitoring device, or the protection monitoring antenna such as the RTLS tag may be configured to be activated or read in a horizontal, vertical, or 360-degree orientation by the RTLS antenna. In another embodiment, RTLS tag may be configured as a single type of RTLS tag or a multiple type RTLS tag such as a mix of brand, vendor, source, style, technology, material, communication protocol such as RFID protocol, internet-of-things (IOT) protocol, cellular protocol, wireless fidelity (Wi-Fi) protocol, Bluetooth protocol, block-chain protocol, or other protocol, or other configuration of RTLS tag. In another embodiment, the RTLS tag may be configured in the form factor of a label, an adhesive label such as a sticker backed label, a glued label, a clip attachment, a magnetic attachment, a cord attachment such as a lanyard on a badge, a non-removable attachment such as permanent glue or adhesive, a removable attachment such as hook-and-loop or removable adhesive, a semi-removable attachment such as non-permanent glue or adhesive, a screw on attachment, a bolt on attachment, a nail on attachment, or other attachable or integral form factor. In another embodiment, the RTLS tag may be reusable such as a reusable RFID tag, reusable a definite number of times, or disposable such as a single use RFID tag or consumable RFID tag. In another embodiment, the RTLS tag may be configured as an indoor tag, an outdoor tag, an indoor/outdoor tag, or other special tag such as a hazardous waste tag. In another embodiment, the RTLS tag may be configured in a form factor that durable in relation to the operating environment. In another embodiment, the RTLS tag may be uniquely serialized such as by a serial number, bulk serialized such as identified by a batch of RFID tags, or not serialized such as for general identification of an RFID tag by part number only. In another application, the RTLS tag may be configured with a sensor such as a temperature sensor, a pressure sensor, a air quality sensor, a carbon monoxide sensor, a altitude sensor, a barometer sensor, a compass sensor, a vibration sensor, an acceleration sensor, or other type of sensor capable of providing additional information to the RTLS system about the RTLS tag's operating environment were the sensor may be fully integrated into the RTLS tag or partially integrated into the RTLS tag. The RTLS tag, may however, be configured in any suitable manner to provide a transponder or a transmitter that may be activated, energized, or polarized by an RTLS antenna or facilitate communication, transmission of data, or function with components of the RTLS system.

The RTLS antenna, according to various aspects of an embodiment of the invention provides for interfacing with RTLS tags and other components of the RTLS system. In one embodiment, the RTLS antenna may comprise a RTLS RFID antenna such as a RFID receiver or RFID reader. In another embodiment, RTLS antenna may comprise an RTLS RFID antenna and a RTLS wireless communication protocol 160. In another embodiment, the RTLS antenna may be configured as a phased-array antenna, a steerable-array antenna, a steerable-phased array antenna, a steerable-phased array bi-directional antenna, a steerable-phased array bi-directional passive RFID antenna 150, a power-over-ethernet RFID steerable phased-array antenna, a RFID antenna, an internet-of-things antenna, a cellular antenna, a Wi-Fi antenna, a Bluetooth antenna, or other applicable antenna suitable for communicating with a RTLS tag. In another embodiment, the RTLS antenna may be configured to read the RTLS tag when the RTLS tag is stationary, when the RTLS tag is moving, or a combination of the RTLS tag being stationary and moving. In another embodiment, the RTLS antenna may be configured as an indoor antenna, an outdoor antenna, or an indoor/outdoor antenna, or other special antenna such as a hazardous waste antenna. In another embodiment, the RTLS antenna may be configured to be mounted to a kiosk 120, a ceiling, a wall, a portal, another surface suitable for accessing the RTLS tag information, or integrated with another type of equipment or surface. In one application, the RTLS antenna may be configured to be mounted flat relative to the ceiling, mounted angled relative to the ceiling to facilitate optimal reading of RTLS tags, or mounted in any other orientation suitable for communicating with a RTLS tag. In another embodiment, the RTLS antenna may be configured to be power internally or externally such as by power over ethernet (POE) such as a POE IEEE 802.3 Type 1 voltage of about 37 to about 57 volts of direct current (VDC) and a current of about 305 mA or a POE IEEE 802.3 Type 2 voltage of about 42 to about 57 VDC and a current of about 600 mA. In another embodiment, the RTLS antenna may be configured in size such as about 23.75″×about 23.75″×about 4″ and weight such as about 15 lbs to achieve a pre-defined range. In another application, the RTLS antenna may be mounted as a single RTLS antenna installation in a location or more than one RTLS antenna installed in a single location. In another application, the RTLS antenna may be configured in a single beam antenna, a multi-beam antenna, a distributed antenna system (DAS), a mesh antenna system or other antenna configuration. The RTLS antenna, may however, be configured in any suitable manner to communicate, activate, energize, or polarize an RTLS tag or facilitate communication, transmission, or function of components of the RTLS system.

In one application, the asset monitoring module may be configured to provide restocking information to the RTLS user when inventory has been depleted to a pre-determined amount and/or in a pre-determined location. In another application, the asset monitoring module may be configured to provide safety monitoring such as providing real-time location of employees and tools in an area where safety may be compromised such as determining if any employees remain in a building during a fire or if any tools remain inside a piece of equipment when the tool should have been returned to its home location. In one application, the asset monitoring module may be configured to alert the RTLS user that an asset has been removed from a pre-defined area such as a tool being removed from a secure area or a pre-defined location without authorization or being checked out. The asset monitoring module, may however, be configured in any suitable manner to track, identify, inspect, manage, secure, or analyze assets or other components of the RTLS system.

The protection monitoring module, according to various aspects of an embodiment of the invention provides a structured framework for collecting, monitoring, and analyzing data related to asset safety and compliance. In one embodiment, the protection monitoring module may comprise a protection monitoring device. In another embodiment, the protection monitoring module may comprise a protection monitoring device and a protection monitoring antenna. In another embodiment, the protection monitoring module may comprise a protection monitoring device, a protection monitoring antenna, and a third-party protection monitoring device.

In one embodiment, the protection monitoring device may be configured as a radiation monitoring device such as a dosimeter 210, a temperature monitoring device, a pressure monitoring device, a contaminant monitoring device, a biological monitoring device, a viral monitoring device, or another monitoring device suitable for obtaining information about a location or the environment around a location or an asset. In one embodiment, the protection monitoring device may be configured with a unique identification such as a protection monitoring device ID.

In one embodiment, the protection monitoring antenna may be configured in any manner suitable for obtaining data from or transmitting to a protection monitoring device such as a RFID protection antenna, a Bluetooth protection antenna, a cellular protection antenna, a Wi-Fi protection antenna, an internet-of-things protection antenna, a hardwired protection connection, a near-field communication (NFC) protection antenna, or other applicable connection with the protection monitoring device. In one application, the protection monitoring module may be configured to provide radiation exposure monitoring such as providing real-time location of employees and employee radiation exposure rates and limits when in a radiation protection area such as in a nuclear power plant.

In one application, the protection monitoring module may be configured as an integration with a third-party application. The protection monitoring module, may however, be configured in any suitable manner to facilitate collection, monitoring, and analyzing data related to asset safety and compliance.

The RTLS communication protocol, according to various aspects of an embodiment of the invention provides a structure for communicating or exchanging information between components of the RTLS system and/or third-party systems. In one embodiment, the RTLS wireless communication protocol may be configured as a the RTLS wireless communication protocol 160 such as a RTLS cellular communication protocol, a RTLS Wi-Fi communication protocol, a RTLS Bluetooth communication protocol, an RTLS internet-of-things wireless communication protocol, a RTS NFC communication protocol, or other suitable communication protocol suitable for facilitating the exchange of information between components of the RTLS system. In another embodiment, RTLS communication protocol may configured as a hardwired communication protocol such as by ethernet. In another embodiment, RTLS communication protocol may be configured as an encrypted communication protocol. In another embodiment, the RTLS communication protocol may be configured as an edge to server communication protocol, an edge-to-edge communication protocol, a RTLS one to many devices communication protocol, a one-to-one communication protocol, a RTLS point-to-point communication protocol, or another network configuration suitable for facilitating the exchange of information between components of the RTLS system. The RTLS communication protocol, may however, be configured in any suitable manner to provide communication between the RTLS tag, the RTLS antenna, and other components of the RTLS system.

The RTLS software, according to various aspects of an embodiment of the invention provides a platform and framework for operating the RTLS system. In one embodiment, the RTLS software may comprise a RTLS user interface. In another embodiment, the RTLS software may comprise a RTLS user interface and a RTLS data schema. In another embodiment, the RTLS software may comprise a RTLS user interface, a RTLS data schema, and a RTLS hardware. In another embodiment, the RTLS software may comprise a RTLS user interface, a RTLS data schema, an optionally configured third-party application, and an optionally configured third-party device. The RTLS software, may however, be configured in any suitable manner to facilitate communication and interface between components of the RTLS system.

The RTLS user interface, according to various aspects of an embodiment of the invention provides for an interface between a user of the RTLS system and the RTLS system. In another embodiment, the RTLS user interface may be configured as a dashboard such as a RTLS dashboard 180, a standard dashboard, a customized dashboard, or a customizable dashboard. In another embodiment, the RTLS user interface may be configured with notifications such as an email notification, a textual notification, a visual notification, an auditory notification, or another type of notification suitable for communicating with the asset or the RTLS user. In another embodiment, the RTLS user interface may be configured to provide varying levels of notifications to the RTLS user such as a warning, an alert, a safety alert such as an employee's exposure to radiation has exceed a pre-determined level, an unauthorized access alert such as an unauthorized employee entering a secure area, or an informational message such as a tool has not been returned within a pre-determined schedule. In another embodiment, the RTLS user interface may be configured as a 2D perspective user interface, or a 3D perspective user interface as shown in FIG. 8 through FIG. 10. In another application, the RTLS user interface may be configured as a 360-degree view, a quadrant view, a form view, a camera view, a streaming view, a gauge view, an equipment view, a thermal view, or a movement tracking view. In another embodiment, the RTLS user interface may comprise a dashboard view indicating the location of a pre-determined group of assets relative to a pre-determined area such as a visual representation of the location of a group of tools that belong in a home location and whether or not those tools are in proximity to the home location or are missing. In one application, the RTLS user interface may be configured to be displayed on a computer, a laptop, a mobile device, a kiosk 120, a web browser interface device, a monitor, a virtual reality device, or other applicable device for visualizing, trending, capturing, analyzing, sharing, or comparing data provided by the RTLS system. In one application, the RTLS user interface may be configured to provide additional information, views, history, or other data when the RTLS user selects or highlights an asset, such as a virtual asset, in the RTLS system. In another application, the RTLS user interface may be configured to provide a virtual reality interface for the RTLS user to interact with the RTLS system such as a virtual reality environment of a 3D scanned room that allows the RTLS user to visually inspect and move around the room 110 while querying the RTLS system for data such as sensor data, camera images, protection monitoring device data, asset data, personnel data, and other data related to the RTS system and operating environment. The RTLS user interface, may however, be configured in any suitable manner to facilitate interface between components of the RTLS system and facilitate interface between the RTLS system and the RTLS user.

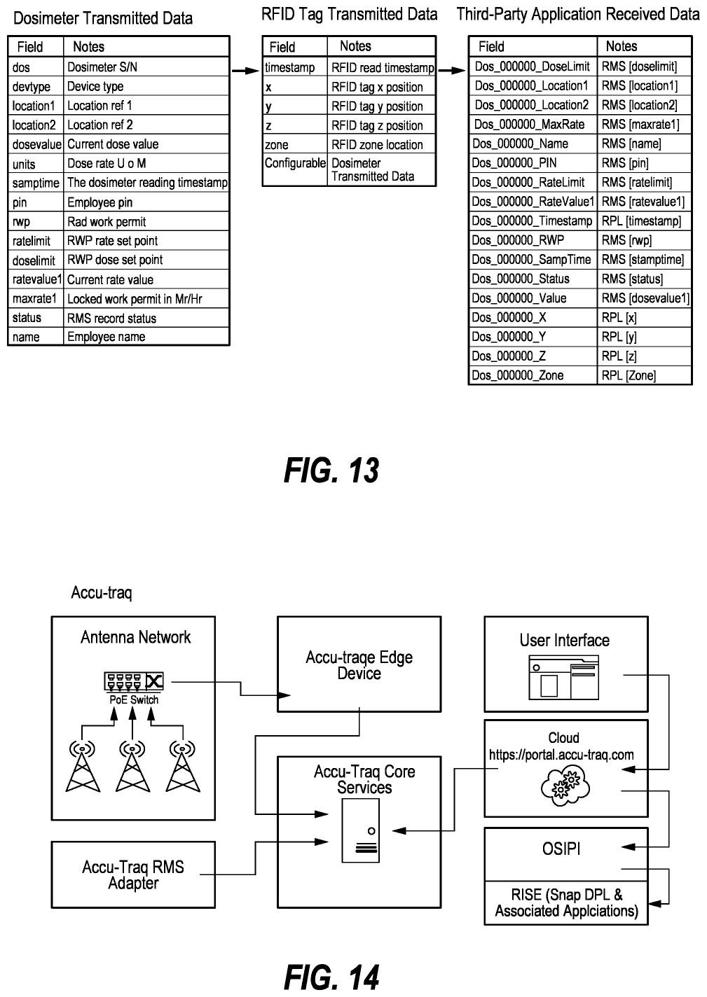

The RTLS data schema, according to various aspects of an embodiment of the invention provides a framework for communication, storage, and display of data related to components of the RTLS system. In one embodiment, the RTLS data schema may be configured to store, manage, or exchange asset related data from components of the RTLS system such as an asset monitoring data such as a location data, a proximity data, a date data, a time data, a parameter data, a primary key data, a foreign key data, a unique identifier data, a serial number data, an electronic product code data, a configurable field data, an asset data, a staff data, an employee data, or another applicable data to the asset monitoring module as shown in FIG. 13. In one embodiment, the RTLS data schema may be configured as an index such as a static index or a dynamically updated index. In another embodiment, the RTLS data schema may be configured to store, manage, or exchange protection monitoring related data from components of the RTLS system such as a protection monitoring data, a protection device data such as a dosimeter 210 data, such as a dosing data, a current dosing amount data, a current dosing limit data, a current dosing limit percentage, a current dose rate data, a current dose rate percentage data, a historical dosing amount data, a historical dosing limit data, a historical dosing limit percentage, a historical dose rate data, a historical dose rate percentage, or another protection device related data as shown in FIG. 13. In another embodiment, the RTLS data schema be configured to store, manage, or exchange protection monitoring related data from components of the RTLS system such as a personnel related data such as security access data, personnel access data, secured authorized area access data such as an unauthorized removal of an asset from an area, issuance data, return data, personal issuance data, personnel return data, return within scheduled time data such as a tool that was not returned in the scheduled amount of time such as within about 8 hours from checkout, or another personnel related data. In another embodiment, the RTLS data schema may be configured to store, manage, or exchange protection monitoring related data from components of the RTLS system and anther third-party application as shown in FIG. 13. In another embodiment, the RTLS data schema may comprise customization based on an industry, an operating environment, a specific customer, a use case, an intended use, a level of security, or other functionality required. The RTLS data schema, may however, be configured in any suitable manner to structure, organize, store, manage, exchange, analyze, or display data related to the components of the RTLS system.

The RTLS hardware, according to various aspects of an embodiment of the invention provides for a platform for operating the RTLS system. In one embodiment, the RTLS hardware may be configured to be installed locally or remotely relative to the location. In another embodiment, the RTLS hardware may be configured as a server such as an antenna network, an edge device, a core services environment, a core server environment, an adapter, a cloud service, a user interface, or other solution configured suitable for operating the RTLS system as shown in FIG. 14. The RTLS hardware, may however, be configured in any suitable manner to provide a user interface, data tracking, data analytics, and data visualization and facilitate communication between components of the RTLS system.

In one embodiment, the third-party application may comprise any suitable system for interfacing with components of the RTLS system such as a generic application interface (API), an external monitoring application such as a radiation monitoring software (RMS) or a database for monitoring dosimeters, an external tracking application such as a data historian software, an external inventory management application such as a vendor managed inventory system for asset tracking or asset restocking, an external employee database, an external security database, an automation control system, an enterprise resource planning (ERP) system, an information technology (IT) system, a telemetry system, a vehicle system, and other systems applicable to operating a business, maintaining safety, or managing inventory. In another embodiment, the third-party application may be configured to export RTLS system data to another third-party system such as RTLS data that may be used for retention, trending, or analysis. In one application, the RTLS system 100 may be configured to integrate and correlate data from a surveillance system such as an alarm system or a camera system such as an internal camera system or an external camera system. In another application, the RTLS system 100 may be configured to interface with a 3D scan of a piece of equipment or a location such as a model or a scan of a room 110 or outside of a building. In one application, the RTLS system 100 may be configured to import and/or export information and/or data to pre-defined forms such as a survey map.

In one embodiment, a third-party device may comprise any suitable system for providing data to components of the RTLS system such as radiation data from a dosimeter 210.

In one embodiment, the RTLS user may be configured as an internal user such as an employee, a staff, a security personnel, or a visitor or an external user such as a vendor, supplier, regulator, external monitoring service, or other entity requiring access to the RTLS system.

In one application, the RTLS system 100 may be configured to wirelessly receive transmitted data where the data that is received is optionally configured as an RFID tag identification and representatively assigned location coordinates such as wireless data transmitted or received by an antenna configured as a phased array bi-directional steerable antenna technology 150 optionally configured that when the antenna is excited by or locates an RFID tag, such as a passive RFID tag, the data may then be transmitted to a database that may be able to retrieve related information associated with the RFID tag identification.

In another application, the RTLS system 100 may be configured without any integration of a third-party application or a third-party device, with some integration of a third-party application or a third-party device, or with only integration of a third-party application or a third-party device.

In another application, the RTLS system 100 may be configured to provide a dashboard view of a radiation protection locator that may display radiation dosing information such as percentage dose, percentage rate of dosing, dosing information relative to a warning level or scale, activity, date, time, or other related information for a staff member displayed as a virtual asset, an avatar, digital twin, or an icon such as a person in a circle in possible proximity to an antenna, a physical location such as a zone such as zone RP Loc 1, zone RP Loc 2, or zone PR Loc 3, a region, such as region CLC556, or a group as shown in FIG. 5.

In another application, the RTLS system 100 may be configured to provide a 2D perspective view of an embodiment of an asset's physical location such as an inventory location, an operations location, an overflow location, or a shelf location such as an upper shelf location wherein by selecting an asset or an object may present or highlight additional information related to the asset or the object such as a location, a name, a tag, or an activity as shown in FIG. 8. In another application, the RTLS system may be configured to display a representative image, such as a drawing, sketch, or model, or an actual image of a room 110, such as a photograph, video, or scan for tracking an employee movement as shown in FIG. 5.

In another application, the RTLS system 100 may be configured to provide a dashboard view that improves the ability for users to make quick decisions where the dashboard data is sourced from an asset locating software solution that may be configured to collect or calculate radiation protection related information such as an employee name, an assigned dosimeter 210, a unique identifier, a received dose, a dosing rate, a dosing rate percentage, a dose, a dose limit, a dose limit percentage, a status, a date, a time, a location, a position, or a proximity where the source data may take a user additional time and analysis in order to make a decision as shown in FIG. 6.

In another application, the RTLS system 100 may be configured to provide a dashboard view that displays an alternative 2D view perspective of an embodiment of a visual dashboard illustrating a possible position of an asset or an object with a virtual RTLS pRFID tag 170B relative to a virtual antenna 150B, a virtual physical location, such as a virtual room 110B, a virtual region, a virtual zone such as a virtual zone 1 711, a virtual zone 2 712, a virtual zone 3 713, a virtual zone 4 714, and a virtual zone 5 715 as shown in FIG. 7.

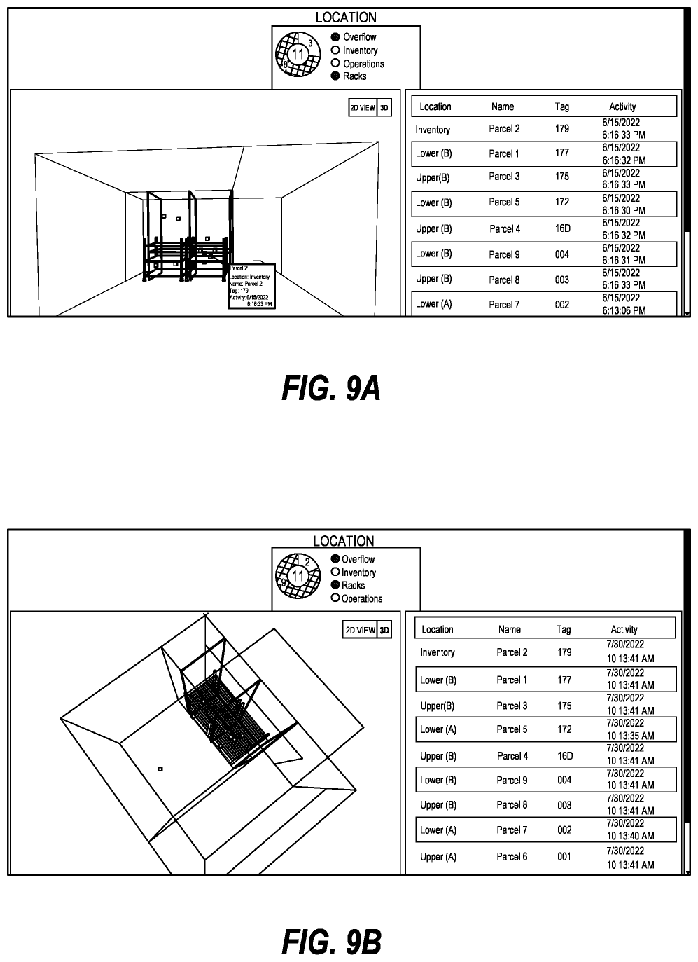

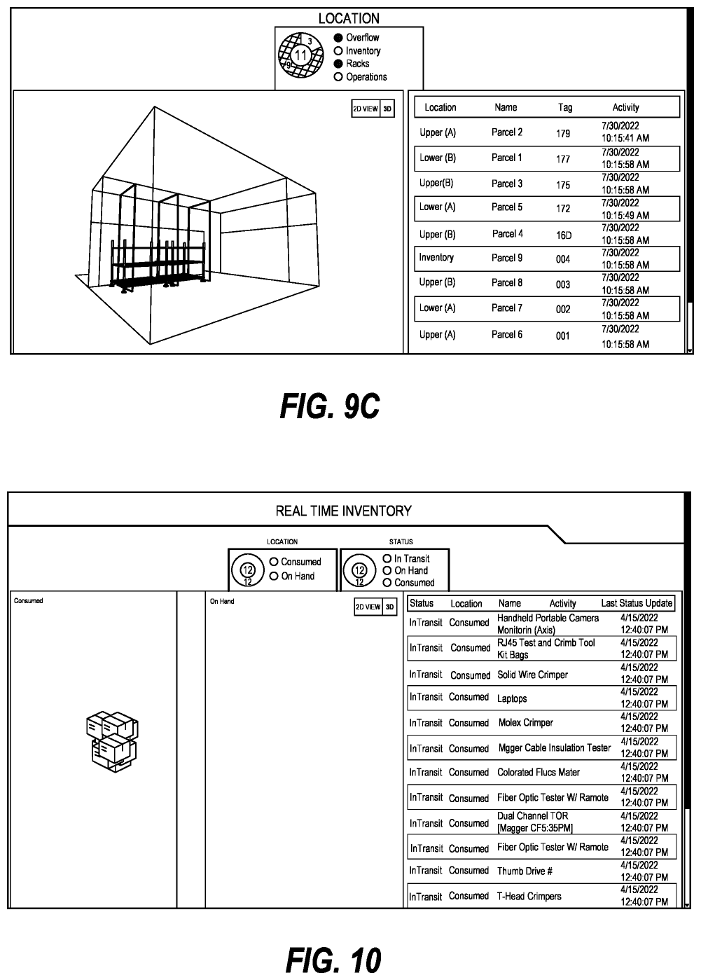

In another application, the RTLS system 100 may be configured to provide a 3D perspective view of an embodiment of a dashboard view of an asset's physical location such as a package 146 on a lower shelf, a middle shelf, or an upper shelf as shown in FIGS. 9A, 9B, and 9C. In another application, the RTLS system 100 may be configured to provide RTLS pRFID tag 170 information and location data in response to a user selecting an asset such as a user selecting a box 144 and the system displaying the box 144 is location in a room 110 on an “upper shelf B” visually and textually as show in FIG. 9C. In another application, the system may display a 2D view or a 3D view of a room 110 such as a 2D view as shown in FIG. 8 displayed as at least one 3D view as shown in FIGS. 9A, 9B, and 9C.

In another application, the RTLS system 100 may be configured to provide a 3D perspective view of an embodiment of a dashboard view of an asset's inventory status such as inventory consumed or inventory on hand as shown in FIG. 10.

In another application, the RTLS system 100 may be configured to provide for collection, recording, or displaying of data associated with an asset location software solution configured to pass transmitted data such as data from a dosimeter 210 and an RFID transponder to a third-party application such as a historical monitoring system as shown in FIG. 13.

In another application, the RTLS system 100 may be configured to provide a current status of some or all assets and/or a historical status of some or all assets. In another application, the RTLS system 100 may be configured to provide asset tracking related to a chain of custody such as a chain of custody for a tool, a chain of custody for a contaminated source material, or a chain of custody for a recalled asset. In another application, the RTLS system 100 may be configured to provide asset tracking related to an asset being located in a predetermined location such as a home location such as for safety if a tool is not returned, cost savings for lost tools and downtime, or for encouragement of compliance to a rule. In another application, the RTLS system 100 may be configured to query and display RTLS system information on the kiosk 120 such as the last personnel to checked out an asset optionally including information such as a serial number, a calibration date, an expiration date, a real time location, a time stamp, and other data applicable to the asset.

In another application, the RTLS system 100 may be configured to record data, such as the RTLS tag's location from an activated RTLS tag within about 0 to about 0.5 milliseconds (ms), about 0 to about 1 millisecond, or about 0 to about 8 milliseconds of activation by an RTLS antenna.

In another application, the RTLS system 100 may be configured to record data, such as the RTLS tag's location of an activated RTLS tag within about 0 inch to about 0.5 inches, 0 inch to about 1 inch, within about 1 inch to about 2 inches, 0 inches to about 18 inches, 0 inches to about 50 inches, about 0 foot to about 3 feet, about a maximum of 90 feet, or farther than about 90 feet of the RTLS tag's actual position.

In another application, the RTLS system 100 may be configured to record data, such as the RTLS tag's location of an activated RTLS tag within a ceiling height of about 0 inches to about 1 foot, about 1 foot to about 10 feet, about 1 foot to about 50 feet, about a maximum of 50 feet, or farther than a ceiling height of 50 feet.

In another application, the RTLS system 100 may be configured to record data, such as the RTLS tag's location of an activated RTLS tag within an accuracy of tag location of about 0 inch to about 0.5 inches, about 0 foot to about 1 foot, about 0 foot to about 3 feet, about 1 foot to about 3 feet, or farther than about 3 feet.

In another application, the RTLS system 100 may be configured to record data, such as the RTLS tag's location, from an RTLS antenna mounted at a scan angle of about in a room 110 where the size of the room 110 is about 0 square foot to about 10 square feet, about 1 square foot to about 500 square feet, about 1 square foot to about 900 square feet, or more than 900 square feet.

In another application, the RTLS system 100 may be configured to record data, such as the RTLS tag's location, from an RTLS antenna mounted at a scan angle of about negative 45 degrees (−45°) to about 45 degrees (45°), about negative 90 degrees (−90°) to about 0 degrees (0°), about 45 degrees (−45°) to about 90 degrees (90°), or about 0 degrees (0°) to about 360 degrees (360°). In another application, the RTLS system 100 may be configured with an antenna mounted in the center of a room or on a wall.

In another application, the RTLS system 100 may be configured to record data over a pre-defined square foot area based upon a pre-defined mounted height of an RTLS antenna such as if the RTLS antenna is mounted on about a 10 foot high ceiling then the RTLS antenna may be configured to read an area of about 10 foot by 10 foot by 4 foot or an area of about 400 square feet or if an RTLS antenna was mounted on about a 40 foot high ceiling then the RTLS may be configured to read an area of about 40 foot by 40 foot by 4 foot or about 6400 square feet. In another application, the RTLS system 100 may be configured to record data in a area defined geometrically such as by an area defined as an upside down triangle. In another application, the RTLS system 100 may be configured to record data using more than one RTLS antenna placed in pre-defined positions or heights that ensure full coverage of a pre-defined area such as one RTLS antenna placed on a ceiling such as in the center of a ceiling, another RTLS antenna placed on a wall such as at a different height than the ceiling and not in the center of the room, and another RTLS antenna at a height that enables reading of RTLS tags near the ground level.

In another application, the RTLS system 100 may be configured to record data, such as the RTLS tag's location, from an RTLS antenna that is configured with a capacity to activate and communicate with about 1 to about 10 RTLS tags simultaneously, about 1 to 100 RTLS tags simultaneously, or more than about 10 RTLS tags simultaneously.

In another application, the RTLS system 100 may be configured to record data, such as the RTLS tag's location, from an RTLS antenna that is configured to read the RTLS tag in an three-axis coordinate system such as x, y, and z, a circular coordinate system, or a polarized continuously coordinate system.

In another application, the RTLS system 100 may be configured to record data, such as the RTLS tag's location, from an RTLS antenna configured to activate a RTLS tag at a lower band such as an European Telecommunications Standards Institute (ETSI) lower band of about 865 to 868 MHz or an upper band such as an ETSI upper band of about 915 to about 921 MHz.

In another application, the RTLS system 100 may be configured to record data, such as the RTLS tag's location, from an RTLS antenna mounted to a ceiling that is about 0 foot to about 5 feet, about 1 foot to about 5 feet, about 1 foot to about 30 feet, about 1 foot to about 50 feet, or about a maximum of 50 feet from a corresponding floor.

In another application the RTLS system 100 may be configured to record data, such as the RTLS tag's location from an RTLS antenna in an indoor environment, an outdoor environment, a hot dry environment, a hot wet environment, a cold dry environment, a wet dry environment, an ambient environment, a humid environment such as humidity range from about 4% relative humidity to about 95% relative humidity, an uncontrolled environment such as an operating temperature from about negative 4 (−4° F.) to about 113 degrees Fahrenheit (113° F.), a controlled environment such as a cleanroom, or an inaccessible environment such as a sealed waste containment storage area.

In another application the RTLS system 100 may be configured to record data, such as the RTLS tag's location from an RTLS antenna with a power level of about 0.2 to about 4 watts effective radiated power (W-EIRP). In another application the RTLS system 100 may be configured to record data, such as the RTLS tag's location from an RTLS antenna with a radiated power of about +24 to about +36 dBm (4 W) EIRP such as an ETSI upper radiated power of about +24 to about +36 dBm (4 W EIRP) or an ETSI lower radiated power of about +24 to about +33 dBm (2 W) EIRP.

In another application, the RTLS system 100 may be configured to be accessed only locally, locally and remotely, or only remotely. In another application, the RTLS system 100 may be configured as a standard off-the-shelf RTLS system, a custom RTLS system, or a customizable RTLS system.

In another application, the RTLS system 100 may be configured as an intelligent pRFID enabled monitored solution such as an asset tracking system comprising a wirelessly connected pRFID tag. In another application, the RTLS system 100 may be configured to interface with artificial intelligence to provide enhance detection of anomalies in components of the RTLS system.

The RTLS system 100, may however, be configured in any suitable manner to facilitate identify, locate, track, inspect, trend, map, survey, capture, analyze, manage, secure, and improve safety of assets and components of the RTLS system.

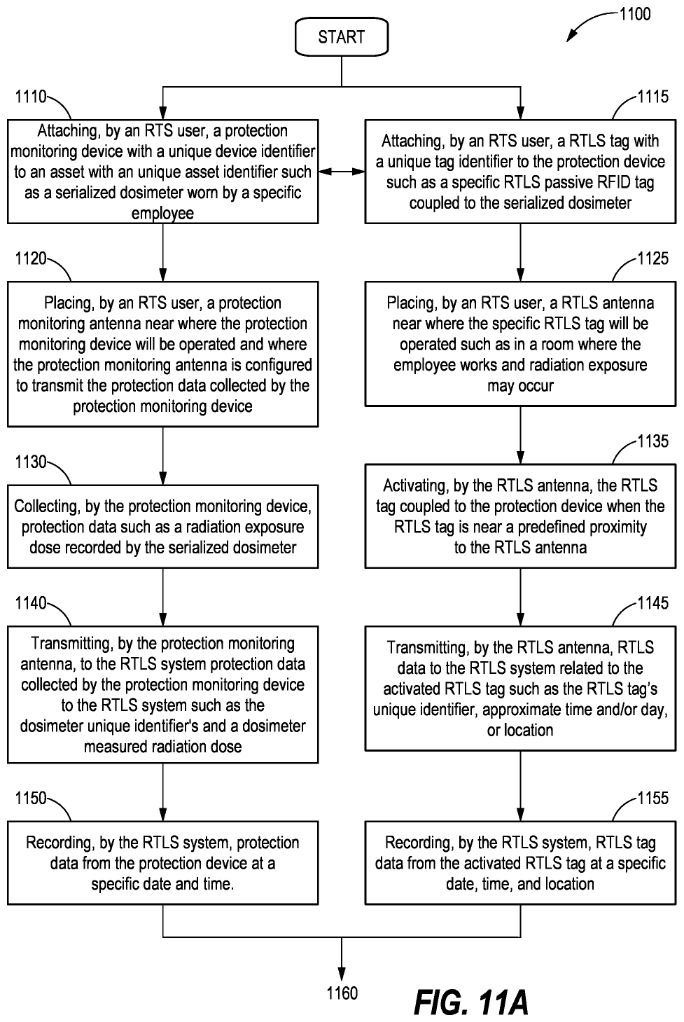

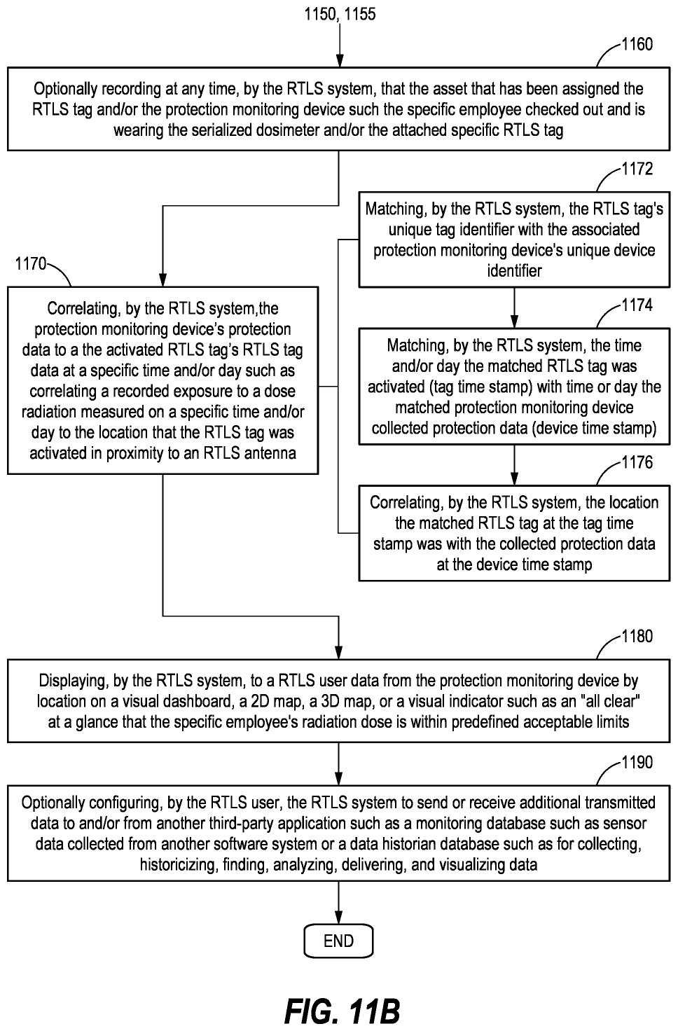

The RTLS system 100 according to various aspects of an embodiment of the invention provides for the collection, recording, and/or displaying of data related to an asset by an RTS user attaching a protection monitoring device with a unique device identifier to an asset with an unique asset identifier such as a serialized dosimeter worn by a specific employee 1110; by an RTS user placing a protection monitoring antenna near where the protection monitoring device will be operated and where the protection monitoring antenna is configured to transmit the protection data collected by the protection monitoring device 1120; the protection monitoring device collecting protection data such as a radiation exposure dose recorded by the serialized dosimeter 1130; the protection monitoring antenna transmitting to the RTLS system protection data collected by the protection monitoring device to the RTLS system such as the dosimeter unique identifier's and a dosimeter measured radiation dose 1140; the RTLS system then recording protection data from the protection device at a specific date and time 1150; while an RTS user may attach a RTLS tag with a unique tag identifier to the protection device such as a specific RTLS passive RFID tag coupled to the serialized dosimeter 1115; and an RTS user places a RTLS antenna near where the specific RTLS tag will be operated such as in a room where the employee works and radiation exposure may occur 1125; then the RTLS antenna may activate the RTLS tag coupled to the protection device when the RTLS tag is near a predefined proximity to the RTLS antenna 1135; then RTLS antenna may transmit RTLS data to the RTLS system related to the activated RTLS tag such as the RTLS tag's unique identifier, approximate time and/or day, or location 1145; then the RTLS system may record RTLS tag data from the activated RTLS tag at a specific date, time, and location 1155; then the RTLS system may correlate the protection monitoring device's protection data to the activated RTLS tag's RTLS tag data at a specific time and/or day such as correlating a recorded exposure to a dose radiation measured on a specific time and/or day to the location that the RTLS tag was activated in proximity to an RTLS antenna 1170; next the RTLS system matches the RTLS tag's unique tag identifier with the associated protection monitoring device's unique device identifier 1172; then the RTLS system matches the time and/or day the matched RTLS tag was activated (tag time stamp) with time or day the matched protection monitoring device collected protection data (device time stamp) 1174; then the RTLS system may correlate the location the matched RTLS tag at the tag time stamp was with the collected protection data at the device time stamp 1176; and the RTLS system may then display to a RTLS user data from the protection monitoring device by location on a visual dashboard, a 2D map, a 3D map, or a visual indicator such as an “all clear” at a glance that the specific employee's radiation dose is within pre-defined acceptable limits 1180 as shown in FIG. 11.

In another application, the RTLS system 100 may be configured to correlate the protection monitoring device's protection data to a the activated RTLS tag's RTLS tag data by using a database to match the RTLS tag with a serial number of an asset that the RTLS tag is attached to such as a person or an equipment and then to retrieve data from another third party system to make a calculation based on real time data retrieved from the other third party system and optionally display the correlation on a dashboard such as a correlation configured as a rate, a percentage (%) of rate, a limit, or a percentage of a limit or other data where the correlation is not limited to just a dose or limit comparison of greater than 80% or greater than 90%.

At any time, the RTLS system may optionally record that the asset that has been assigned the RTLS tag and/or the protection monitoring device such the specific employee checked out and is wearing the serialized dosimeter and/or the attached specific RTLS tag 1160 as shown in FIG. 11. The RTLS user may optionally configure the RTLS system to send or receive additional transmitted data to and/or from another third-party application such as a monitoring database such as sensor data collected from another software system or a data historian database such as for collecting, historicizing, finding, analyzing, delivering, and visualizing data 1190 as shown in FIG. 11.

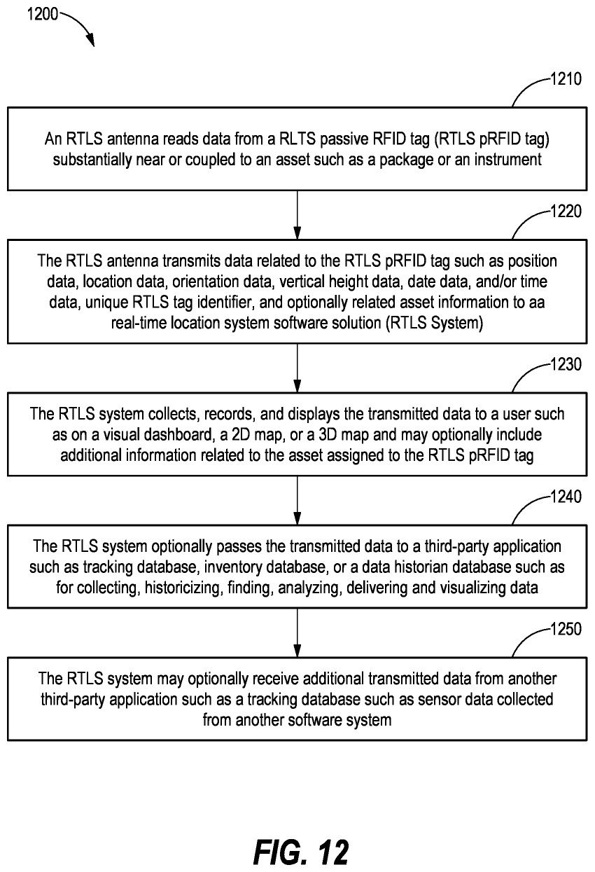

The RTLS system 100 according to various aspects of an embodiment of the invention provides for the collection, recording, and displaying of data related to an asset such as location or position of asset such as by an RTLS antenna reading data from a RTLS pRFID tag substantially near or coupled to an asset such as a package or an instrument 1210; the RTLS antenna transmitting data related to the RTLS pRFID tag such as position data, location data, orientation data, vertical height data, date data, time data, unique RTLS tag identifier, and optionally related asset information to aa real-time location system software solution (RTLS System) 1220; where the RTLS system collects, records, and displays the transmitted data to a user such as on a visual dashboard, a 2D map, or a 3D map and may optionally include additional information related to the asset assigned to the RTLS pRFID tag 1230; the RTLS system may then optionally pass the transmitted data to a third-party application such as a tracking database, an inventory database, or a data historian database such as for collecting, historicizing, finding, analyzing, delivering and visualizing data 1240; and where the RTLS system may optionally receive additional transmitted data from another third-party application such as a tracking database such as sensor data collected from another software system 1250 as shown in FIG. 12.

In places where the description above refers to particular implementations of systems and methods for a real-time asset locating software solution with an intuitive dashboard, it should be readily apparent that a number of modifications may be made without departing from the spirit thereof and that these implementations may be applied to other to systems and methods for a real-time asset locating software solution with an intuitive dashboard.

What is claimed is:

1. An asset location system comprising:
an asset monitoring module comprising a structured framework for collecting, monitoring, and analyzing data related to asset identification, inspection, tracking, management, security, and compliance;
a protection monitoring module comprising a structured framework for collecting. monitoring and analyzing data related to asset safety and compliance;
a Real-Time Inventory Management System (“RTLS”) communication protocol comprising a structure for communicating or exchanging information between components of the RTLS system and/or third-party systems;
a RTLS software configured to provide a platform and a framework for the RTLS system, and
a RTLS user interface.

2. The asset location system of claim 1 wherein the asset monitoring module comprises an asset, a RTLS tag and a RTLS antenna.

3. The asset location system of claim 1 wherein the asset monitoring module comprises an asset, a RTLS tag a RTLS antenna and a third party monitoring device.

4. The asset location system of claim 1 wherein the asset monitoring module may be configured to provide restocking information via the RTLS user interface when the inventory of a tagged asset has been depleted to a predetermined level.

5. The asset location system of claim 1 wherein the asset monitoring module may be configured to provide the real time location of an asset.

6. The asset location system of claim 1 wherein the protection monitoring module comprises a radiation monitoring device.

7. The asset location system of claim 1 wherein the protection monitoring module comprises a protection monitoring antenna selected from a group consisting of a RFID protection antenna, a Bluetooth protection antenna, a cellular protection antenna, a Wi-Fi protection antenna, an internet-of-things protection antenna, a hardwired protection connection and a near-field communication (NFC) protection antenna.

8. The asset protection system of claim 1 wherein the RTLS comprises a wireless communication protocol selected from a group consisting of a RTLS cellular communication protocol, a RTLS Wi-Fi communication protocol, a RTLS Bluetooth communication protocol, an RTLS internet-of-things wireless communication protocol and a RTS NFC communication protocol.

9. The asset protection system of claim 1 wherein the RTLS user interface is configured as a customizable dashboard.

10. The asset protection system of claim 1 wherein the RTLS user interface is configured with notifications from a group consisting of an email notification, a textual notification, or a visual notification:

11. The asset protection system of claim 1 wherein the RTLS user interface is configured to provide a three-dimensional perspective.

12. An asset location and protection system comprising:
an RTLS tag configured to uniquely identify and locate an asset, the RTLS tag ID further comprising a sensor capable of providing with additional asset information to the RTLS system about the RTLS tag's operating environment;
a protection monitoring module comprising a structured framework for collecting, monitoring and analyzing data related to asset safety and compliance;
a Real-Time Inventory Management System (“RTLS”) communication protocol comprising a structure for communicating or exchanging information between components of the RTLS system and/or third-party systems;
a RTLS software configured to provide a platform and a framework for the RTLS system, and
a RTLS user interface, the RTLS user interface being operable to provide an interface configured to provide a three-dimensional user interface comprising a three dimensional area wherein the RTLS user can visually inspect and move around the room while querying the RTLS system for data such as sensor data, camera images, protection monitoring device data, asset data, personnel data, and other data related to the RTLS system and operating environment.

13. A method for tracking the location of a tagged asset within a defined area, the method comprising the steps of:
defining an area in which assets are to be located, tracked and monitored;
attaching a Real Time Asset Locating System (RTLS) tag to at least one asset to make a tagged asset;
associating a protection monitoring device to the at least one tagged asset, the protection monitoring device comprising at least a protection monitoring device antenna;
providing at least one Real Time Asset Locating System (“RTLS”) antenna, the at least one RTLS antenna being capable of locating, tracking and monitoring a RTLS tag on an asset;
providing a RTLS software;
providing a RTLS communication protocol comprising a structure for communicating and exchanging information between the protection monitoring device, the RTLS antenna and the RTLS software; and
providing a RTLS user interface, the RTLS user interface operable to display the location of the asset using a three dimensional perspective user interface and information provided by the protection monitoring device.

14. The method for tracking the location of a tagged asset within a defined area of claim 13 wherein the protection monitoring device is a radiation protection device or dosimeter.

15. The method for tracking the location of a tagged asset within a defined area of claim 13 wherein the protection monitoring device is a dosimeter and the RTLS user interface is configured to provide an alert when the dosimeter's exposure to radiation exceeds a certain level.

16. The method for tracking the location of a tagged asset within a defined area of claim 13 wherein the user interface is configured to provide an alert, or trigger an action when an asset is located outside the defined area.

17. The method for tracking the location of at least one tagged asset within a defined area of claim 13 wherein the user interface is configured to provide a three-dimensional perspective view of the at least one asset in the defined area.
